(19) United States
(12) Patent Application Publication
(10) Pub. No.: US 2005/0013770 A1
(43) Pub. Date: Jan. 20, 2005

(54) Method for storing hydrogen in an hybrid form

(76) Inventors: Robert Schulz, Ste Julie (CA); Guoxian Liang, Longueuil (CA); Jacques Huot, Cap De La Madeleine (CA); Patrick Larochelle, Ste Julie (CA)

Correspondence Address: HAYNES AND BOONE, LLP, 901 MAIN STREET, SUITE 3100, DALLAS, TX, 75202, US

(21) Appl. No.: 10/753,869

(22) Filed: Jan. 8, 2004

Related U.S. Application Data
(63) Continuation-in-part of application No. 09/894,010, filed on Jun. 29, 2001.
(60) Provisional application No. 60/533,422, filed on Dec. 30, 2003.

(51) Int. Cl. B65D 85/00; C01B 3/06

(52) U.S. Cl. 423/658.2; 423/657; 206/.7

(57) ABSTRACT

The present invention relates to a hydrogen storage container containing at least an hydrogen storage composition and hydrogen, the hydrogen including solid state hydrogen and gaseous hydrogen, the hydrogen storage composition including at least a portion of the solid state hydrogen and having an high equilibrium plateau pressure, wherein the solid state hydrogen defines at least 5% by weight of the total weight of the contained hydrogen, and wherein the gaseous hydrogen has a pressure greater than the high equilibrium plateau pressure and defines at least 5% by weight of the total weight of the contained hydrogen.

### RELATED APPLICATIONS

This application is a continuation-in-part of U.S. patent application Ser. No. 09/894,010, filed Jun. 29, 2001, and claims the benefit of U.S. Provisional Patent Application (number unknown) filed Dec. 30, 2003 for “Method For Storing Hydrogen in an Hybrid Form).

### FIELD OF THE INVENTION

The present invention relates to a method for storing hydrogen in a hybrid form. More specifically, it relates to a method for storing hydrogen in two different forms within a single tank.

The invention also relates to tanks hereinafter called “hybrid tanks”, which are specially adapted for carrying out the above method when the hydrogen is stored in liquid and solid forms and when the hydrogen is stored in solid and gaseous forms, respectively.

### BACKGROUND OF THE INVENTION

Methods for storing hydrogen can be classified in three main categories:
(A) gaseous storage in high pressure tanks;
(B) liquid storage in cryogenic tanks; and
(C) solid storage in tanks containing materials that absorb (in volume) or adsorb (on surface) hydrogen.

The last category listed above as category (C) is the one that makes use of metal hydride storage tanks.

Each of the above categories has advantages and disadvantages that are summarized in the following Table 1:

TABLE I
Characteristics of the different methods for storing hydrogen

| Storing method | Advantages | Disadvantages |
|---|---|---|
| (A) Gaseous | The filling and discharge kinetics (sec- | Very low storage capacity per volume unit and, |
| | min) is very fast | accordingly, the necessity of using very large tanks |
| | The tanks are very light weight because | Very high gas pressure is required to have a sufficient |
| | they are made of composite material | amount of hydrogen per volume unit (up to 10000 psi |
| | | 690 bars) |
| | | Significant loss of energy because mechanical |
| | | compression is required to achieve the requested |
| | | pressure level (15-20%). |
| | | Risk of explosion or deflagration due to the very high |
| | | pressure |
| (B) Liquid | Excellent storage capacity per volume | Problem of evaporation of liquid hydrogen (boil off) |
| | unit | Significant loss of energy because refrigeration is |
| | | required to reach the requested temperatures (30%) |
| (C) Solid (hydrides) | Excellent storage capacity per volume | Very low filling and discharge kinetics since the |
| “Hydrogen absorption in | which sometimes exceeds the one of | absorption and desorption of hydrogen is limited by |
| volume” | liquid storage | the heat transfer (min-hr) |
| Solid (adsorbents) | High storage capacity for some materials | Low storage capacity per weight unit because of the |
| “Hydrogen adsorption | of high specific surface (activated | high weight of the absorbent material |
| on surface” | carbon, etc . . . ) | Significant loss of thermal energy for inducing |
| | High storage capacity for some materials | hydrogen desorption (10-25%) |
| | of high specific surface (activated | Necessity of using very low temperatures (liquid |
| | carbon, etc . . . ) | nitrogen) to obtain a high storing capacity |

By way of example, in the case of a method for storing hydrogen in a gaseous form (category A), a tank of one (1) liter will contain the following amounts of hydrogen at the various pressures indicated in Table II:

TABLE II
Gaseous storage

| Hydrogen pressure | Amount of hydrogen within one liter |
|---|---|
| 3,600 psig (248 bar) | 0.0177 kg |
| 5,000 psig (345 bar) | 0.0233 kg |
| 8,000 psig (550 bar) | 0.0334 kg |
| 10,000 psig (690 bar) | 0.0392 kg |
| 15,000 psig (1,035 bar) | 0.0512 kg |

In the case of a method for storing hydrogen in a liquid form (category B), a tank of one (1) liter will contain 0.0708 kg of hydrogen since the density of liquid hydrogen at −252.8° C. (that is at the conventional boiling point of hydrogen) is equal to 0.0708 kg/I.

Last of all, in the case of a method for storing hydrogen in a solid form with a metal hydride (category C), a tank of one (1) liter containing a hydride of formula AB₅ such as LaNi₅H₆ (density: 6.59 kg/l, hydrogen storage capacity of about 1.4%), occupying the complete volume of the tank, will contain 0.0923 kg of hydrogen. That is almost twice the amount of hydrogen stored in a gaseous form in a tank of one liter at 15,000 psig.

The results of this comparative example are given in Table III:

TABLE III
Comparison of the storage capacity of the
thru basic methods for storing hydrogen

| | Amount of hydrogen |
|---|---|
| | stored within tank of |
| Method | one liter |
| (A) Gaseous storage at 15,000 psig (1,035 bar) | 0.0512 kg |
| at ambient temperature | |
| (B) Liquid storage at −252.8 C. (1 bar) | 0.0708 kg |
| (C) Solid storage in a hydride of LaNi₅ | 0.0923 kg |
| (10 bar) at ambient temperature | |

Of course, in the case of the method for storing hydrogen in a liquid form (category B), there is always some gaseous hydrogen in equilibrium with the liquid because of some evaporation of the latter. Also, in the case of the method for storing hydrogen in a solid form with a metal hydride (category C), operating at low pressure (10 bar), there is some gaseous hydrogen because the hydride never occupies all the space in the tank. Moreover, in the case of the method for storing hydrogen in a gaseous form at a very high pressure (category A), there is always some hydrogen that is adsorbed (such adsorbed hydrogen is also called “solid hydrogen” according to the above terminology) onto the internal walls of the tank. Therefore, in each method listed hereinabove (gaseous, liquid and solid), there is always a small amount of hydrogen that is stored according to another method of storage.

By way of example, the maximum percentage of hydrogen that may come from another method of storage in the case of a tank of one liter containing a metal hydride powder (LaNi₅H₆) is evaluated. Assuming that the powder is not compacted and, therefore, occupies about half of the volume of the tank (about 0.5 liter), considering also that the density of LaNi₅H₆ is equal to 6.59 kg/l, and further assuming that the gaseous hydrogen within the tank (about 0.5 liter) is at a pressure of 10 bar, the amount of hydrogen that is not solid within the tank of one liter is reported in Table IV:

TABLE IV

| “Gaseous” hydrogen | | Total amount |
|---|---|---|
| (10 bar) | “Solid” hydrogen | of hydrogen |
| 0.00041 kg (0.9%) | 0.0462 kg (99.1%) | 0.0466 kg (100%) |

This example clearly shows that, for any given method of storage, there can usually be 1% of hydrogen stored in a different form. However, in all cases, this amount will always be lower than 5% by weight.

It has already been suggested that there could be some advantages in combining different means for storing hydrogen within a single tank.

By way of example, U.S. Pat. No. 5,906,792 discloses that there are advantages when one combines a low temperature metal hydride with a high temperature metal hydride in contact with each other within the same tank. When such a mixture is used for an internal combustion engine, the low temperature metal hydride allows cold starting of the engine by providing the hydrogen at the start up. When the engine is hot, the heat that is generated effects desorption of hydrogen from the high temperature metal hydride.

Similarly, international laid-open patent application No. WO 01/16021 discloses that there are some advantages in combining solid storage in the volume (absorption) with solid storage on the surface (adsorption) in nanoparticles of a hydride in order to improve, inter alia, the hydrogen absorption and desorption kinetics.

U.S. Pat. No. 5,872,074 also discloses that the hydrogen sorption kinetics can be improved when use is made of a hydride having high specific surface.

Independently of the above, it is also known that the method (C) for storing hydrogen in a solid form usually has a response time (loading and unloading) much slower than the method (A) for storing hydrogen in a gaseous form and slower than the method (B) for storing hydrogen in a liquid form.

Actually, at least 15 minutes, and sometimes more than 1 hour, is required to fill up a hydride storage tank. In spite of this drawback, the method for storing hydrogen in a solid form has the highest capacity of storage per volume unit (see Table III).

It is known that some technical applications require a response time much faster than one minute.

For example, in UPS systems (uninterruptible power supply) using fuel cells fed with hydrogen, a response time of about one hundred milliseconds is usually required. Of course, a hydrogen storing tank using metal hydride cannot satisfy this particular requirement. However, in such a case, use could be made of a tank in which hydrogen is stored in a gaseous form at high pressure.

Similarly, in hydrogen operated vehicles, there are different types of transitory periods, such as:
(i) short duration accelerations which usually require a response time of about one hundred milliseconds from the propulsion system; and
(ii) power increases when the vehicle is climbing up a hill, which may last a few minutes.

In hybrid vehicles which make use of a fuel cell and batteries, the very short accelerations (lasting for a few seconds) are powered by the batteries, whereas the transitory periods of a longer duration (a few minutes) may depend on gaseous hydrogen for fuel. On the other hand, the average power, which is about 20 KW for a typical vehicle, may easily be accommodated by a metal hydride tank. The energy contained in the batteries of such a vehicle usually represents about 1% of the energy on board. Therefore, one needs an amount of hydrogen greater than 1% to function as an energy source during the transitory periods.

In summary, in view of the above, it is obvious that there presently is a need for a method for storing hydrogen which would combine the advantages of the different methods listed hereinabove.

### SUMMARY OF THE INVENTION

The present invention provides a new method for storing hydrogen which combines the advantages of at least two of the above mentioned methods for storing hydrogen, namely the methods for storing hydrogen in a gaseous form, in a liquid form and in a solid form.

The present invention provides a single tank, hereinafter referred to as a “hybrid tank for storing hydrogen”, for storing hydrogen using at least two of the above-mentioned methods, namely:
(A) the method for storing hydrogen in a gaseous form
(B) the method for storing hydrogen in a liquid form; and
(C) the method for storing hydrogen in a solid form (i.e. solid state hydrogen), in the space defined by the tank or on the surface of the tank wall.

The only condition is that each of the above methods is used for storing at least 5% by weight of the total amount of hydrogen within the tank.

Therefore, the invention as claimed is directed to a method for storing hydrogen in an hybrid form, which comprises the step of combining and using within a single tank at least two hydrogen storage means selected from the group consisting of:
a) means for storing hydrogen in a gaseous form
b) means for storing hydrogen in a liquid form; and
c) means for storing hydrogen in a solid form by absorption or adsorption,
with the proviso that each of the storing means that are used, is configured to store at least 5% by weight of the total amount of hydrogen stored within the tank.

The means mentioned hereinabove for storing hydrogen in different forms are those commonly used for carrying out each of the above mentioned methods. They are very conventional and need not be further described in detail. The only requirement is that they be combined within the same tank, and that each of the means be used for storing at least 5% by weight of the hydrogen.

Another aspect of the present invention is to provide a hybrid tank for storing hydrogen in both liquid and solid forms, comprising two concentric containers, one of the containers, hereinafter called the “inner” container, is located within the other one, which is hereinafter called the “outer container”, the containers being separated by an insulating sleeve for maintaining the inner container at low temperature. The inner container is used for storing hydrogen in a liquid form. The outer container is in direct communication with the inner container and contains a metal hydride for storing hydrogen in a solid form.

A further aspect of the present invention is to provide a hybrid tank for storing hydrogen in both solid and gaseous forms, comprising:
a container having a metallic liner or inner wall covered with a polymeric outer shell, said container being devised to store hydrogen in gaseous form at a higher pressure and to receive and store a metal hydride in order to store hydrogen in solid form;
at least one heat pipe mounted within the container to allow circulation of a heat carrying fluid; and
a heat exchanger located within the container in order to ensure thermal connection between said at least one heat pipe and the hydride.

In another broad aspect, the present invention provides a hydrogen storage container containing at least an hydrogen storage composition and hydrogen, the hydrogen including solid state hydrogen and gaseous hydrogen, the hydrogen storage composition including at least a portion of the solid state hydrogen and having an high equilibrium plateau pressure, wherein the solid state hydrogen defines at least 5% by weight of the total weight of the contained hydrogen, and wherein the gaseous hydrogen has a pressure greater than the high equilibrium plateau pressure and defines at least 5% by weight of the total weight of the contained hydrogen.

In a further broad aspect, the present invention provides a system for converting chemical energy stored in hydrogen into mechanical energy comprising a hydrogen storage container defining a storage space containing at least an hydrogen storage composition and hydrogen, the hydrogen including solid state hydrogen and gaseous hydrogen, the hydrogen storage composition including at least a portion of the solid state hydrogen and having an high equilibrium plateau pressure, wherein the gaseous hydrogen has a pressure greater than the high equilibrium plateau pressure, and an engine fluidly coupled to the container for receiving the gaseous hydrogen, the engine being configured to effect conversion of the chemical energy stored in gaseous hydrogen delivered from the container to the engine into mechanical energy.

In another further broad aspect, the present invention provides a system for converting chemical energy stored in hydrogen into mechanical energy comprising a hydrogen storage container containing at least an hydrogen storage composition and hydrogen, the hydrogen including solid state hydrogen and gaseous hydrogen, the hydrogen storage composition including at least a portion of the solid state hydrogen and having an equilibrium desorption plateau pressure at 20° C. of greater than 40 bar, wherein the gaseous hydrogen has a pressure greater than the equilibrium desorption plateau pressure of the hydrogen storage composition, and a fuel cell fluidly coupled to the container for receiving the gaseous hydrogen.

In yet another further broad aspect, the present invention provides a system for converting chemical energy stored in hydrogen into mechanical energy comprising a hydrogen storage container containing at least an hydrogen storage composition and hydrogen, the hydrogen including solid state hydrogen and gaseous hydrogen, the hydrogen storage composition including at least a portion of the solid state hydrogen and having an equilibrium desorption plateau pressure at 20° C. of greater than 40 bar, wherein the gaseous hydrogen has a pressure greater than the equilibrium desorption plateau pressure of the hydrogen storage composition, and a vehicular engine fluidly coupled to the container for receiving the gaseous hydrogen.

In yet a further broad aspect, the present invention provides a method of effecting hydrogenation of a hydrogen storage composition disposed in a container space defined by a hydrogen storage container configured for containing at least hydrogen and the hydrogen storage composition, the hydrogen storage composition having an high equilibrium plateau pressure, comprising the step of flowing gaseous hydrogen into the container space so as to effect hydrogenation of the hydrogen storage composition at least until the hydrogen storage composition includes solid state hydrogen and the solid state hydrogen defines at least 5% by weight of the total weight of hydrogen disposed within the container space, and so as to effect filling of the container space with the gaseous hydrogen at least until the gaseous hydrogen disposed within the container space defines at least 5% by weight of the total weight of the hydrogen disposed within the container space.

In one aspect, the gaseous hydrogen defines at least 15% by weight of the total weight of the contained hydrogen.

In another aspect, the gaseous hydrogen defines at least 19% by weight of the total weight of the contained hydrogen.

In another aspect, the gaseous hydrogen defines at least 28% by weight of the total weight of the contained hydrogen.

In yet another aspect, the gaseous hydrogen defines at least 50% by weight of the total weight of the contained hydrogen.

In yet a further aspect, the gaseous hydrogen has a pressure of at least 248 bars.

In yet another aspect, the gaseous hydrogen has a pressure of at least 345 bars.

In another aspect, the gaseous hydrogen has a pressure of at least 690 bars.

In a further aspect, the hydrogen storage composition has an equilibrium desorption plateau pressure at 20° C. of greater than 40 bars, and the gaseous hydrogen has a pressure greater than the equilibrium desorption plateau pressure.

In a further aspect, the hydrogen storage material is a metalliferous material.

In yet another aspect, the metalliferous material is a metal hydride.

In yet another aspect, the metal hydride is in particulate form.

In a further aspect, the hydrogen storage composition has an equilibrium desorption plateau pressure at 20° C. of greater than 80 bars, and the gaseous hydrogen has a pressure greater than the equilibrium desorption plateau pressure.

In yet a further aspect, the hydrogen storage composition has an equilibrium desorption plateau pressure at 20° C. of less than 120 bars.

In a further aspect, the gaseous hydrogen defines at least 50% by weight of the total weight of the contained hydrogen and has a pressure of at least 345 bars.

### BRIEF DESCRIPTION OF THE DRAWINGS

This invention will be better understood by reference to the following detailed description of the invention in conjunction with the following drawings, in which:

FIG. 1 is a diagram illustrating the equilibrium plateau of an hydride contemplated for use in a hybrid gas-solid storage tank disclosed in example 1;

FIG. 2 is a schematic cross-sectional view of the hybrid liquid-solid storage tank disclosed in example 2;

FIG. 3 is a diagram illustrating the equilibrium plateau of an hydride contemplated for use in the hybrid gas-solid storage tank disclosed in example 3;

FIG. 4 is a schematic cross-sectional view of the hybrid gas-solid storage tank disclosed in example 3;

FIGS. 5 and 6 are diagrams giving the equilibrium plateau of several hydrides as a function of the temperature and indicating which one could be used in the hybrid gas-solid storage tank disclosed in examples 1 and 3; and

FIG. 7 is a diagram illustrating the relationship between reaction heat (desorption heat or absorption heat) and equilibrium plateau pressure (absorption or desorption).

### DETAILED DESCRIPTION

### EXAMPLE 1

### Hybrid storage Tank for Storing Hydrogen in Gas and Solid Forms

For purposes of illustrating a hybrid storage tank of the present invention, a hydrogen storage tank having a volume of 1 liter can be provided and filled with a powder of nanoparticles of a hydride of LaNi₅ having an average diameter of 5 nanometers. The powder would occupy 50% by volume of the tank, (i.e. 0.5 liters), since it would not be compacted. The number of atoms on the surface of these nanoparticles would represent about 28% of the total amount of atoms within each particle considering a layer of 0.4 to 0.5 nanometer on the surface of each nanoparticle. The tank could then been filled up with gaseous hydrogen at different pressures ranging from 10 bar (typical pressure of use of the metal hydride tanks) to 700 bars (typical pressure used in high pressure gaseous tanks). It is assumed that the amount of hydrogen in the volume and at the surface of the metal hydride corresponds to H/M=1 (H=hydrogen, M=metal), which is typical for most metal hydrides. Under these conditions, the amounts of hydrogen that would be associated to the two different means of storage, have been calculated and are reported in Table V hereinafter:

TABLE V

| | | | Hydrogen | | | | |
|---|---|---|---|---|---|---|---|
| Hydrogen | | | bound | | Hydrogen | | |
| pressure | Hydrogen in | | connected to | | inserted | | Total amount |
| within the | gaseous phase | | the surface of | | within the | | of hydrogen |
| tank | (kg) | % | the hydride | % | hydride | % | (kg) |
| 10 bar* | 0.0004 | 1 | 0.0142 | 28 | 0.0365 | 71 | 0.0511 |
| 150 psi | | | | | | | |
| 248 bar | 0.0089 | 15 | 0.0142 | 24 | 0.0365 | 61 | 0.0596 |
| 3600 psi | | | | | | | |
| 345 bar | 0.0117 | 19 | 0.0142 | 23 | 0.0365 | 58 | 0.0624 |
| 5000 psi | | | | | | | |
| 690 bar | 0.0196 | 28 | 0.0142 | 20 | 0.0365 | 52 | 0.0703 |
| 10000 psi | | | | | | | |

It is worth noting that in the first case reported in Table V, that is when the pressure is 150 psi (10 bar), the amount of hydrogen in gaseous phase represents about 1% of the total amount. This example is illustrative of what is presently obtained in conventional metal hydride tanks and is therefore outside the scope of the present invention. However, in the three other cases reported hereinabove, where the pressures are of 3,600 psi, 5,000 psi and 10,000 psi, the amounts of hydrogen in gaseous phase represents about 15%, 19% and 28% respectively of the total amount of hydrogen within the tank. This is much higher than the limit of 5% as indicated hereinabove.

The tank disclosed in example 1 is illustrative of a tank that can be used in a “back up” system based on a fuel cell or a hydrogen source generator. In the case of a failure of the electric supply, the hydrogen in the gaseous phase will initially supply the fuel cell or the generator while such fuel cell or generator will slowly warm up. The pressure within the tank will be reduced. When the pressure reaches the equilibrium plateau of the hydride, that is about 2 bars for an AB₅ alloy at room temperature, there will be almost no more hydrogen in the gaseous phase. Then, the hydride will take over by supplying hydrogen to the fuel cell or the generator.

It is worth noting that, in this example, the equilibrium desorption plateau pressure of a hydride of LaNi₅ which is a conventional low temperature metal hydride at the operating temperature (typically ranging between 0 to 100° C.), is slightly higher than the pressure of hydrogen required at the inlet of the fuel cell, which is typically about 2 bars. If the tank contains 50% by volume of hydride and the balance is occupied with gaseous hydrogen at 690 bars (10,000 psi), the situation will correspond to that of the diagram given in FIG. 1.

Under such circumstances, during operation of the system, the hydrogen will first be supplied by the gaseous phase. Then, when the amount of hydrogen and, concomitantly, the gas pressure become low, the hydride will take over by providing hydrogen to the system. The pressure within the tank will then be kept at the level of the desorption plateau of the hydride. The kinetics of the system will therefore be quite high at the beginning (response time of the gaseous system) and thereafter relatively low (response time of the hydride system).

There are also other advantages in using such a hybrid method combining gas and solid storage, particularly:
a) refilling of the tank is carried out in a short time as compared to conventional metal hydride tanks;
b) the design of the heat transfer components of the tank is simplified; and
c) the high storage capacity by volume of the metal hydride.

### EXAMPLE 2

### Hybrid Tank for Storing Hydrogen in Liquid and Solid Forms

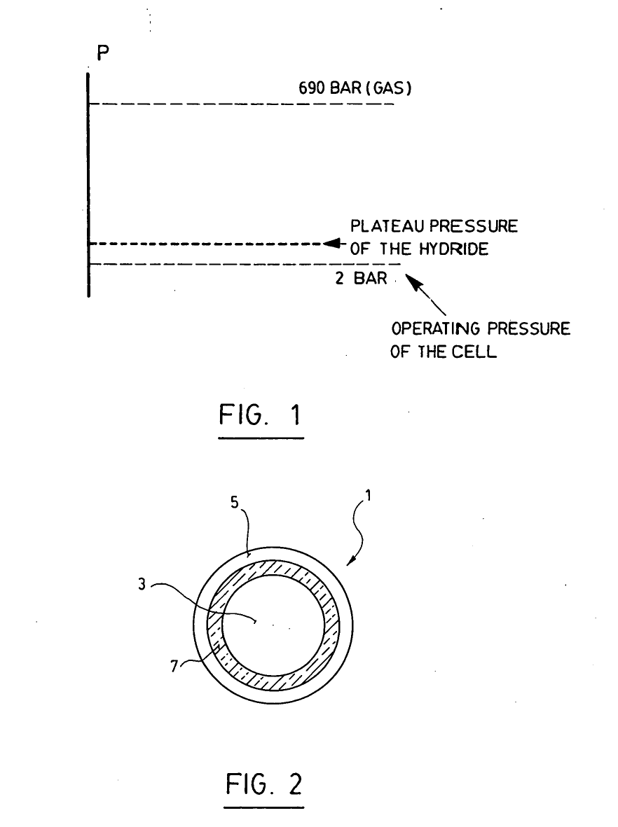

An hybrid tank 1 for storing hydrogen having a total volume of one liter comprises two concentric containers 3,5 (see FIG. 2). The inner container 3 has a volume of 0.8 liter whereas the outer container 5 has a volume of 0.2 liter. An insulating sleeve 7 is positioned between the inner and the outer containers 3,5 to keep the inner container 3 at low temperature.

When in use, the inner container 3 of the tank 1 is filled up with liquid hydrogen. The inner container 3 would contain about 0.0708 kg/1×0.8 liter=0.0566 kg of hydrogen. The outer container 5 is then filled with a powder of a metal hydride of the type LaNi₅H₆ so as to occupy about 50% of the volume, that is about 0.1 liter. Therefore, the outer container 5 would contain 6.59 kg/1×0.1 liter ×1.4%=0.0092 kg of hydrogen. The total amount of hydrogen stored within the tank 1 would be equal to 0.0658 kg (14% in the outer tank and 86% in the inner tank).

As compared to a conventional tank for storing hydrogen in a liquid form, the tank disclosed in example 2 has the advantage of having essentially no loss of hydrogen over a period that may exceed two weeks. Indeed, the problem with any conventional liquid hydrogen storage tank is that the hydrogen evaporates (boil off). Up to 1% of the amount of liquid hydrogen can evaporate each day from a conventional tank (1%×0.0566 kg=0.0006 kg/day). In the hybrid tank disclosed in example 2, the boil-off hydrogen is absorbed by the metal hydride (disposed in the periphery of the inner container) up to its maximum capacity (that is 0.0092 kg/0.0006 kg/day=15 days).

It is worth noting that the idea of using metal hydrides for “catching” evaporated hydrogen from a liquid hydrogen storage tank has already been suggested, but by means of two separate systems that must be interrelated, connected and independently controlled. In this regard, one can refer to U.S. Pat. No. 5,728,483. In contrast, in the present invention, these two different means for storing hydrogen are combined within a single tank and therefore operate in a simpler manner.

### EXAMPLE 3

### Hybrid Tank for Storing Hydrogen in Gas-Solid Form For Use in a System Having Transitory Periods

In the tank disclosed in example 1, use of LaNi₅H₆ is contemplated as the hydride. This compound is known to have a low equilibrium plateau pressure (viz. lower than 40 bars). Use could also be made of other hydride, with a low equilibrium plateau pressure, such as NaAlH₄ or MgH₂.

According to the invention, it is also possible to use also a hydrogen storage composition having an equilibrium plateau that is much higher at relative temperatures (typically ranging between 0° C. and 100° C.) than the equilibrium plateau of the conventional hydrides (typically ranging between 1 to 10 bars at these temperatures). Such an high equilibrium plateau is 40 bars or higher. In one embodiment, the hydrogen storage composition has an equilibrium desorption plateau pressure at 20° C. greater than 40 bars. Examples of such hydrogen storage compositions include the following dehydrogenated metalliferous materials which, upon hydrogenation, become metal hydrides having an equilibrium desorption plateau pressure greater than 40 bars at 20° C.: Ti_{0.95}Zr_{0.05}CrMn, TiCr_{1.25}Mn_{0.75}, TiCr_{1.5}Mn_{0.5}, Ti_{1.2}Cr_{1.9}Mn_{0.1}, Ti_{0.95}Zr_{0.05}Cr_{1.2}Mn_{0.8}, Ti_{0.95}Zr_{0.05}Cr_{1.2}Mn_{0.6}Co_{0.2}, Ti_{0.95}Zr_{0.05}Cr_{1.2}Mn_{0.75}V_{0.05}.

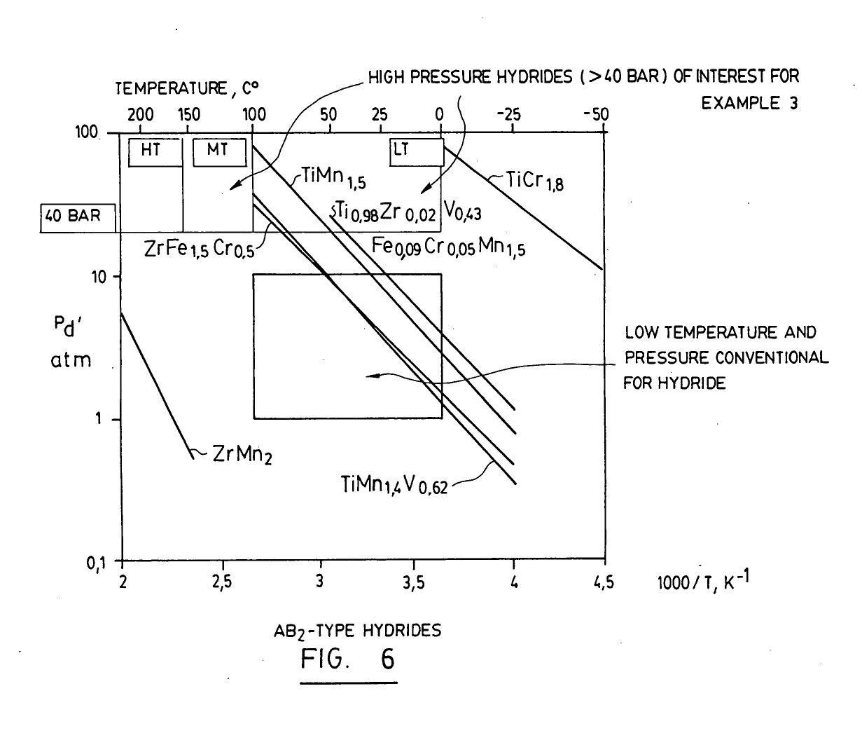

An example of a low temperature hydride which has an equilibrium plateau at room temperature much higher than 100 bars is a hydride of TiCr_{1.8} (see FIG. 6). There are also medium temperature hydrides with equilibrium plateau at high pressures, such as hydrides of TiMn_{2-y}, Hf₂Cu, Zr₂Pd, TiCu₃ or V_{0.855} Cr_{0.145} which can be of interest for this kind of application (see FIGS. 5 and 6).

Preferably, the hydrogen storage composition has an equilibrium desorption plateau pressure greater than 80 bars at 20° C. An example of such hydrogen storage compositions of this type include metalliferous materials which, upon hydrogenation, become metal hydrides having an equilibrium desorption plateau pressure greater than 80 bars at 20° C., include: TiCr_{1.8}, TiCr_{1.25}Mn_{0.75}, TiCrMn, and LiAlH₄. Use of a hydrogen storage composition having an equilibrium desorption plateau pressure at 20° C. of greater than 40 bars, and even more preferably of 80 bars, mitigates or eliminates the need for heat transfer components to facilitate heat transfer within a hydrogen storage tank.

There are several reasons why use of such high equilibrium plateau pressure hydrogen storage compositions in a hydrogen storage container reduce the need for heat transfer components. These include:
1. Desired hydrogen desorption rates achieved at lower rate of heat input;
2. Lower reaction heat during hydrogen absorption;
3. Lower reaction heat during hydrogen desorption; and
4. Superior heat conductivity of high pressure hydrogen being absorbed or desorbing from the hydrogen storage composition.

When hydrogen storage compositions having high equilibrium plateau pressures are used, the driving force for hydrogen desorption is relatively higher than with lower equilibrium plateau pressure compositions, and acceptable rates of hydrogen desorption can be achieved with relatively slower heat input. The rate of hydrogen desorption from a hydrogen storage composition is a function of, amongst other things, the differential pressure driving force (i.e., the driving force) defined by the difference between the actual hydrogen gas pressure in the hydrogen storage container and the desorption plateau pressure of the hydrogen storage composition. Gaseous hydrogen in the tank must exist at a sufficiently high pressure (>2 bars) in order to supply hydrogen at a satisfactory rate to a downstream operation (such as a fuel cell or an internal combustion engine). For hydrogen storage compositions having a lower equilibrium desorption plateau pressure, the driving force is lower than for hydrogen storage compositions having a higher equilibrium desorption plateau pressure. This means that faster heat input is required to effect adequate hydrogen desorption rates for lower equilibrium plateau pressure hydrogen storage compositions than for higher equilibrium plateau pressure hydrogen storage compositions. As a consequence, the need for heat transfer components to facilitate the necessary heat input is not as critical for the higher equilibrium plateau pressure hydrogen storage compositions.

Faster hydrogen desorption is also not as critical for hybrid containers using high equilibrium plateau pressure hydrogen storage compositions for the reason that adequate amounts of gaseous hydrogen are more likely to be present in the container while hydrogen is desorbing from the hydrogen storage composition, relative to a hybrid container using a lower equilibrium plateau pressure hydrogen storage composition. For the high equilibrium plateau pressure hydrogen storage composition case, hydrogen desorbs at a relatively high pressure. When such hydrogen is being desorbed, there is a relatively significant (in comparison to the low equilibrium plateau pressure hydrogen storage composition case) amount of gaseous hydrogen in the container. Because there is a relatively significant amount of gaseous hydrogen in the container while the hydrogen is being desorbed from the hydrogen storage composition, it is not as critical to effect fast desorption of hydrogen from the hydrogen storage composition, as adequate gaseous hydrogen can be supplied from the gaseous hydrogen already present in the container. In this respect, the gaseous hydrogen provides a “buffer” time before the rate of hydrogen desorption becomes more critical to the supply of gaseous hydrogen from the container.

The second and third reasons why the need for heat transfer components is reduced when high equilibrium plateau pressure hydrogen storage compositions are used are based upon the fact that the hydrogen absorption and desorption phenomena are characterized by lower reaction heats (relative to lower equilibrium plateau pressure hydrogen storage compositions). This is confirmed thermodynamically by the Van't Hoff equation:

$$ln ( Peq ) = \frac{Δ H}{RT} - \frac{Δ S}{R}$$

For example, the heat of formation (ie: absorption of hydrogen) for a hydrogen storage composition having an equilibrium absorption plateau pressure of 1 bar at 300 k is 34 kJ/mol.H₂. In contrast, the heat of formation for a hydrogen storage composition having an equilibrium absorption plateau pressure of 80 bars is 20 KJ/mol.H₂, which is only 60% of the reaction heat of the lower plateau pressure composition.

Referring to the second reason, relative to an hydrogen storage composition having a lower equilibrium plateau pressure, (such as 40 bars at 20° C.), an hydrogen storage composition having an equilibrium plateau pressure at 20° C. of greater than 80 bars releases less heat energy during hydrogen absorption. Release of heat energy is a potential concern as temperatures could escalate, increasing the equilibrium absorption plateau pressure, and thereby requiring a higher gaseous hydrogen pressure to effect absorption of hydrogen by the hydrogen storage composition when it is desired to form the hydrogenated state of the hydrogen storage composition. To mitigate against requiring a higher gaseous hydrogen pressure to effect the hydrogen absorption, heat transfer components are typically provided in the tank to effect removal of the heat energy during hydrogen absorption. In this respect, heat transfer components are less likely required (or not required to the same extent) for systems having an hydrogen storage compositions with an equilibrium desorption plateau pressure at 20° C. greater than 80 bars than for systems having an hydrogen storage composition with a lower equilibrium desorption plateau pressure (for example, 40 bars at 20° C.).

Referring to the third reason, heat transfer components are also required to a lesser degree in systems using metal hydrides having a high equilibrium plateau pressure (such as greater than 80 bar at 20° C.), for the reason that the heat of desorption is less for higher equilibrium plateau pressure compositions. Hydrogen desorption is an endothermic reaction, requiring an input of heat energy. The delivery of heat energy is less critical for a hydrogen storage composition having an equilibrium desorption plateau pressure, at 20° C., of greater than 80 bar, relative to an hydrogen storage composition having a lower equilibrium desorption plateau pressure (for example, 40 bar at 20° C.). This is because heat input is less critical for hydrogen desorption of higher equilibrium plateau pressure hydrogen storage compositions. In this respect, heat transfer components are more critical for systems using lower equilibrium desorption plateau pressure hydrogen storage compositions.

A further reason why the need for heat transfer components is mitigated or eliminated in the case of a system with an hydrogen storage composition having high equilibrium plateau pressures is because of the superior heat transfer characteristics of gaseous hydrogen at higher pressures. Hydrogen being absorbed by or desorbed from a high equilibrium plateau pressure composition has a higher pressure than hydrogen being absorbed by or desorbed from a low equilibrium plateau pressure composition. This means that heat transfer characteristics during hydrogen absorption/desorption for containers having high equilibrium plateau pressure compositions are superior to those for containers having lower equilibrium plateau pressure compositions. This factor further reduces the reliance on heat transfer components for containers having high equilibrium plateau pressure hydrogen storage compositions.

The reduction or elimination of heat transfer components improves the gravimetric storage capacity of the hydrogen storage container. By such reduction or elimination, a large volume of the container becomes accessible for hydrogen storage, thereby improving gravimetric storage capacity.

Preferably, towards reducing or eliminating heat transfer components while concomitantly optimizing gravimetric storage capacity, the present invention provides a hydrogen storage container containing at least an hydrogen storage composition and hydrogen, the hydrogen including solid state hydrogen and gaseous hydrogen, wherein the gaseous hydrogen defines at least 50% by weight of the total weight of the contained hydrogen and has a pressure of at least 345 bars. The hydrogen storage composition includes at least a portion of the solid state hydrogen and has an high equilibrium desorption plateau pressure. The solid state hydrogen defines at least 5% by weight of the total weight of the contained hydrogen.

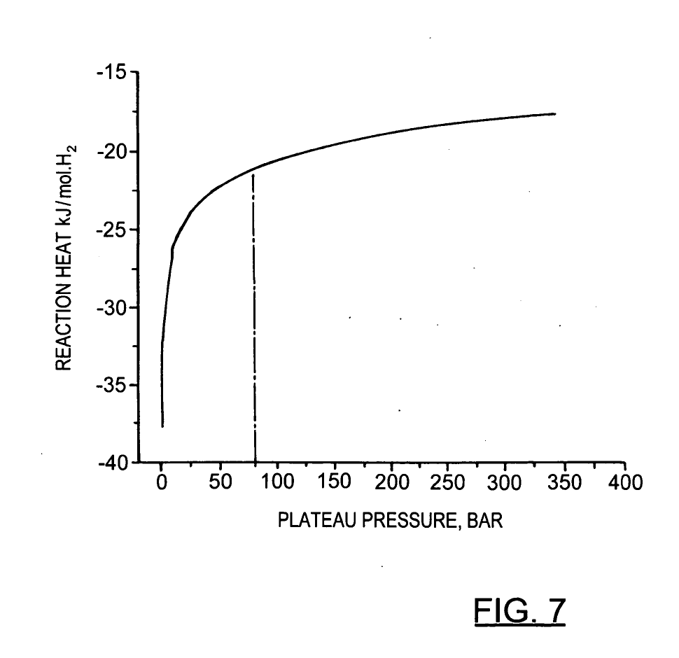

More preferably, the hydrogen storage composition has an equilibrium desorption plateau pressure greater than 80 bars at 20° C. and less than 120 bars at 20° C. As discussed above, heat of desorption decreases as equilibrium desorption plateau pressure increases. However, above an equilibrium plateau pressure of 80 bars, the reduction in the heat becomes less significant with increasing desorption plateau pressure. This is because of the logarithmic relationship between the heat of desorption and equilibrium desorption plateau pressure, as governed by the above-mentioned Van't Hoff equation (see FIG. 7).

As equilibrium desorption plateau pressure increases, so does the equilibrium absorption plateau pressure for a given hydrogen storage composition. In the extreme, the pressure required to charge the hydrogen storage composition may become challenging when the equilibrium desorption plateau pressure is above 150 bars. Hydrogen absorption is an exothermic reaction. Generation of heat energy during hydrogen absorption increases the temperature of the hydrogen storage composition. As the temperature of the hydrogen storage composition increases, the equilibrium absorption plateau pressure also increases. As a result, unless the generated heat is being transferred away at a sufficient rate from the hydrogen storage composition, the hydrogen storage composition becomes more difficult to charge with hydrogen (i.e. higher pressure hydrogen is required to effect absorption of hydrogen by the hydrogen storage composition). To mitigate this refuelling problem, heat transfer means must be provided to effect fast heat transfer from the hydrogen storage composition to control the increase in temperature. Alternatively, high pressure hydrogen gas must be provided to effect charging of the hydrogen storage composition. In the extreme, charging of a hydrogen storage composition with a relatively high equilibrium absorption plateau pressure may become impractical due to technology challenges which must be overcome to effect the desired heat transfer or the supply of hydrogen at a desired high pressure. For example, where the equilibrium absorption plateau pressure is 150 bars at 20° C., heat generated by the hydrogen storage composition may result in an increase in temperature of the hydrogen storage composition such that the corresponding equilibrium absorption plateau pressure increases to well above 350 bars. Given the current technology, it is desirable to maintain the charging pressure between about 350-400 bars, although it is possible to exceed this. In this respect, it is preferable that the equilibrium desorption plateau pressure is 120 bars.

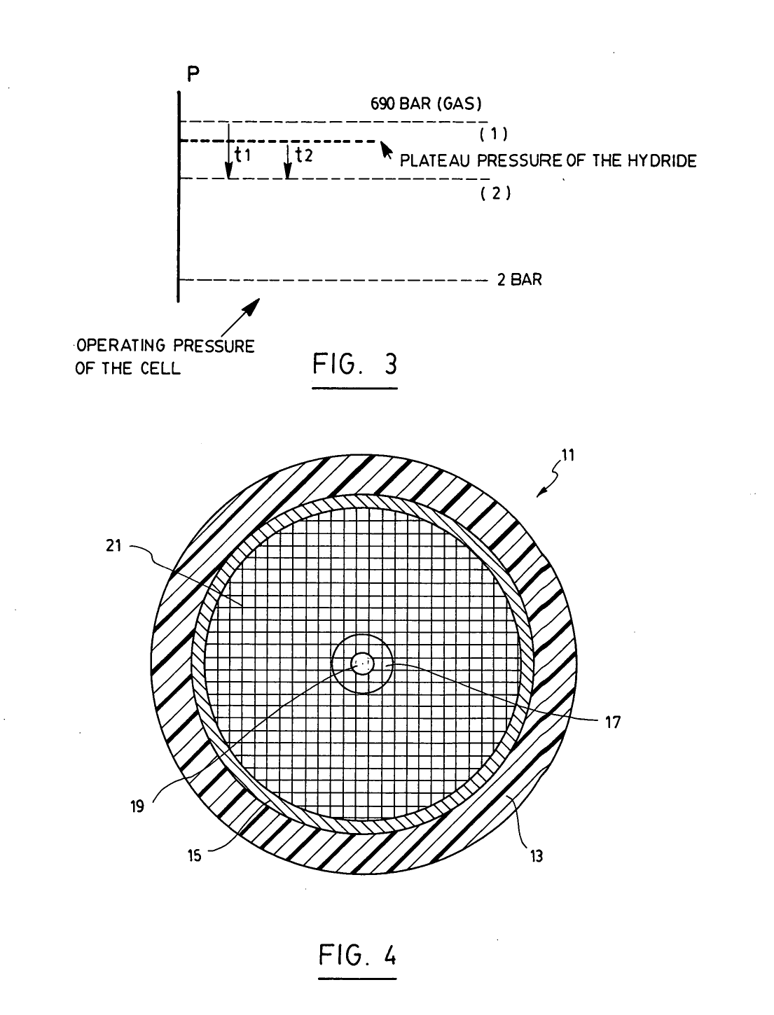

When there is a need for hydrogen, the gaseous system of the storage tank will permit to accommodate such a request with a very short response time (t1) of about one second (for example in the case of a car that accelerates). When the pressure within the tank drops and changes from a value (1) to a value (2) (see FIG. 3), the hydride will regenerate the gaseous system with a lower response time (t2) of a few minutes, until the next acceleration.

It is understood, however, that a “hybrid” hydrogen storage container containing pressurized gaseous hydrogen and a high equilibrium plateau pressure hydrogen storage composition (such as those described above) is not limited to use in systems having transitory periods. Rather, such containers are useful for supplying gaseous hydrogen for any application requiring a source of gaseous hydrogen, including fuel cells, internal combustion engines, and hydrogen compressors.

This hybrid method makes it possible to substantially simplify the structural components required for heat transfer in order to induce the desorption from the hydride or absorption thereby. Moreover, this hybrid storage method mitigates the problem of refilling hydrides such as LiAlH₄ by requiring filling of the tank with relatively high pressure gas. As to the kind of hydrides that can be used, reference can be made to FIG. 5 (hydrides of the AB₅ type) and FIG. 6 (hydrides of the AB₂ type) enclosed herewith.

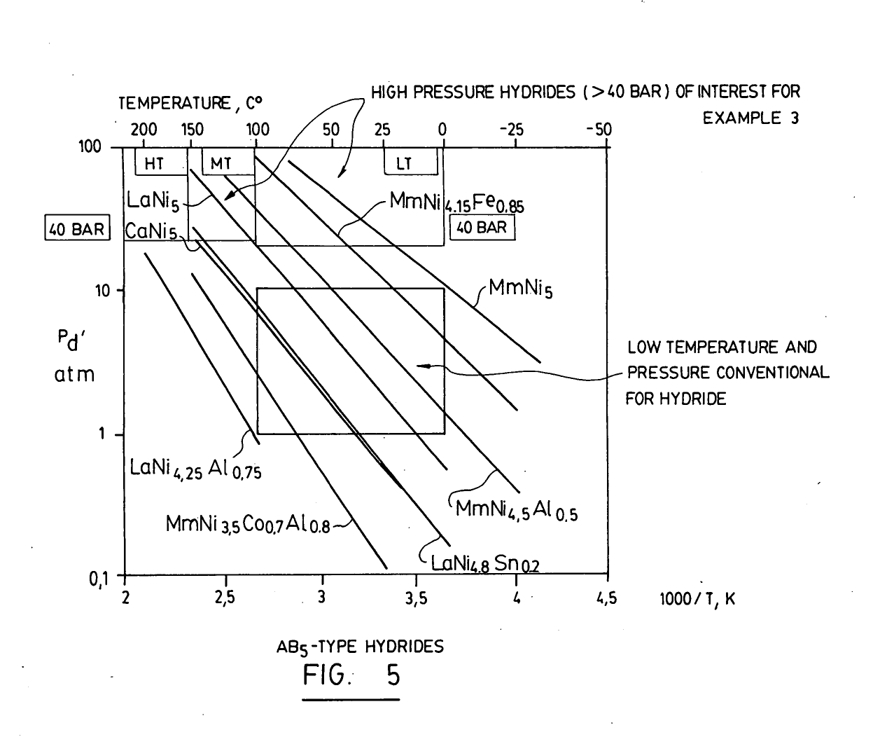

As an example of the way this method could be carried out, reference can be made to FIG. 4 which shows a hybrid tank 11 for storing hydrogen in both solid and gaseous form. The tank 11 comprises a container having a metallic liner or inner wall 15 covered with a polymeric outer shell 13. This type of container is conventional and commonly used for storing hydrogen in gaseous form at high pressure. It is preferably cylindrical in shape and provided with an axial opening 17. The liner 15 is usually made of aluminium whereas its outer shell is made of a composite material reinforced with carbon fibers. In practice, the container of the hybrid tank 11 is intended to be used for storing hydrogen in gaseous form at a pressure usually higher than 40 bar and simultaneously to receive and store a metal hydride in order to store hydrogen in solid form as well.

At least one heat pipe 19 is mounted within the container to allow the circulation of a heat carrying fluid within the container 11. As shown, the tank 11 preferably comprises only one heat pipe 19 which is inserted into the container through the opening 17 and extends axially within the same. The tank 11 further comprises a heat exchanger located within the container to ensure thermal connection between the heat pipe 19 and the hydride. This heat exchanger preferably consists of at least one metallic grid, or a porous metallic structure or fibers 21 which extends transversally within the container and is in direct contact with the axial heat pipe 19, the metal liner wall 15 of the container, and the hydride stored within the same.

The use of such a system of heat pipe and heat exchanger to operate a metal hydride is already known (see, for example, U.S. Pat. No. 6,015,041). In the present case, one aspect of the invention resides in the incorporation of such a system into a tank used so far only for storing hydrogen in a gaseous form at high pressure in order to benefit from the advantages of both technologies simultaneously.

It will be understood, of course, that modifications can be made to the embodiments of the invention described herein without departing from the scope and purview of the invention as defined by the appended claims.

1. A hydrogen storage container containing at least an hydrogen storage composition and hydrogen, the hydrogen including solid state hydrogen and gaseous hydrogen, the hydrogen storage composition including at least a portion of the solid state hydrogen and having an high equilibrium plateau pressure, wherein the solid state hydrogen defines at least 5% by weight of the total weight of the contained hydrogen, and wherein the gaseous hydrogen has a pressure greater than the high equilibrium plateau pressure and defines at least 5% by weight of the total weight of the contained hydrogen.

2. The hydrogen storage container as claimed in claim 1, wherein the gaseous hydrogen defines at least 15% by weight of the total weight of the contained hydrogen.

3. The hydrogen storage container as claimed in claim 2, wherein the gaseous hydrogen defines at least 19% by weight of the total weight of the contained hydrogen.

4. The hydrogen storage container as claimed in claim 3, wherein the gaseous hydrogen defines at least 28% by weight of the total weight of the contained hydrogen.

5. The hydrogen storage container as claimed in claim 4, wherein the gaseous hydrogen defines at least 50% by weight of the total weight of the contained hydrogen.

6. The hydrogen storage container as claimed in claim 1, wherein the gaseous hydrogen has a pressure of at least 248 bars.

7. The hydrogen storage container as claimed in claim 6, wherein the gaseous hydrogen has a pressure of at least 345 bars.

8. The hydrogen storage container as claimed in claim 7, wherein the gaseous hydrogen has a pressure of at least 690 bars.

9. The hydrogen storage container as claimed in claim 1, wherein the hydrogen storage composition has an equilibrium desorption plateau pressure at 20° C. of greater than 40 bars, and the gaseous hydrogen has a pressure greater than the equilibrium desorption plateau pressure.

10. The hydrogen storage container as claimed in claim 9, wherein the hydrogen storage material is a metalliferous material.

11. The hydrogen storage container as claimed in claim 10, wherein the metalliferous material is a metal hydride.

12. The hydrogen storage container as claimed in claim 11, wherein the metal hydride is in particulate form.

13. The hydrogen storage container as claimed in claim 9, wherein the hydrogen storage composition has an equilibrium desorption plateau pressure at 20° C. of greater than 80 bars, and the gaseous hydrogen has a pressure greater than the equilibrium desorption plateau pressure.

14. The hydrogen storage container as claimed in claim 13, wherein the hydrogen storage composition has an equilibrium desorption plateau pressure at 20° C. of less than 120 bars.

15. The hydrogen storage container as claimed in claim 14, wherein the hydrogen storage material is a metalliferous material.

16. The hydrogen storage container as claimed in claim 15, wherein the metalliferous material is a metal hydride.

17. The hydrogen storage container as claimed in claim 16, wherein the metal hydride is in particulate form.

18. The hydrogen storage container is claimed in claim 14, wherein the gaseous hydrogen defines at least 50% by weight of the total weight of the contained hydrogen and has a pressure of at least 345 bars.

19. A system for converting chemical energy stored in hydrogen into mechanical energy comprising:
a hydrogen storage container defining a storage space containing at least an hydrogen storage composition and hydrogen, the hydrogen including solid state hydrogen and gaseous hydrogen, the hydrogen storage composition including at least a portion of the solid state hydrogen and having an high equilibrium plateau pressure, wherein the gaseous hydrogen has a pressure greater than the high equilibrium plateau pressure; and
an engine fluidly coupled to the container for receiving the gaseous hydrogen, the engine being configured to effect conversion of the chemical energy stored in gaseous hydrogen delivered from the container to the engine into mechanical energy.

20. The system as claimed in claim 19, wherein the solid state hydrogen defines at least 5% by weight of the total weight of the contained hydrogen and the gaseous hydrogen defines at least 5% by weight of the total weight of the contained hydrogen.

21. The system as claimed in claim 20, wherein the gaseous hydrogen defines at least 15% by weight of the total weight of the contained hydrogen.

22. The system as claimed in claim 21, wherein the gaseous hydrogen defines at least 19% by weight of the total weight of the contained hydrogen.

23. The system as claimed in claim 22, wherein the gaseous hydrogen defines at least 28% by weight of the total weight of the contained hydrogen.

24. The system as claimed in claim 23, wherein the gaseous hydrogen defines at least 50% by weight of the total weight of the contained hydrogen.

25. The system as claimed in claim 19, wherein the gaseous hydrogen has a pressure of at least 248 bars.

26. The system as claimed in claim 25, wherein the gaseous hydrogen has a pressure of at least 345 bars.

27. The system as claimed in claim 26, wherein the gaseous hydrogen has a pressure of at least 690 bars.

28. The system as claimed in claim 19, wherein the hydrogen storage composition has an equilibrium desorption plateau pressure at 20° C. greater than 40 bars, and the gaseous hydrogen has a pressure greater than the equilibrium desorption plateau pressure.

29. The system as claimed in claim 28, wherein the hydrogen storage composition is a metalliferous material.

30. The system as claimed in claim 29, wherein the metalliferous material is a metal hydride.

31. The system as claimed in claim 30, wherein the metal hydride is in particulate form.

32. The system as claimed in claim 31, wherein the engine includes a fuel cell.

33. The system as claimed in claim 28, wherein the hydrogen storage composition has an equilibrium desorption plateau pressure at 20° C. of greater than 80 bars, and the gaseous hydrogen has a pressure greater than the equilibrium plateau pressure.

34. The hydrogen storage container as claimed in claim 33, wherein the hydrogen storage composition has an equilibrium desorption plateau pressure at 20° C. of less than 120 bars.

35. The system as claimed in claim 34, wherein the hydrogen storage composition is a metalliferous material.

36. The system as claimed in claim 35, wherein the metalliferous material is a metal hydride.

37. The system as claimed in claim 36, wherein the metal hydride is in particulate form.

38. The system as claimed in claim 37, wherein the engine includes a fuel cell.

39. The system as claimed is in claim 38, wherein the gaseous hydrogen defines at least 50% by weight of the total weight of the contained hydrogen and has a pressure of at least 345 bars.

40. A system for converting chemical energy stored in hydrogen into mechanical energy comprising:
a hydrogen storage container containing at least an hydrogen storage composition and hydrogen, the hydrogen including solid state hydrogen and gaseous hydrogen, the hydrogen storage composition including at least a portion of the solid state hydrogen and having an equilibrium desorption plateau pressure at 20° C. of greater than 40 bars, wherein the gaseous hydrogen has a pressure greater than the equilibrium desorption plateau pressure of the hydrogen storage composition; and
a fuel cell fluidly coupled to the container for receiving the gaseous hydrogen.

41. The system as claimed in claim 38, wherein the hydrogen storage composition has an equilibrium desorption plateau pressure at 20° C. of greater than 80 bars.

42. The hydrogen storage container as claimed in claim 40, wherein the hydrogen storage composition has an equilibrium desorption plateau pressure at 20° C. of less than 120 bars.

43. The system as claimed in claim 40, wherein the hydrogen storage composition is a metalliferous material.

44. The system as claimed in claim 43, wherein the hydrogen storage composition is a metal hydride.

45. The system as claimed in claim 44, wherein the solid state hydrogen defines at least 5% by weight of the total weight of the contained hydrogen and the gaseous hydrogen defines at least 5% by weight of the total weight of the contained hydrogen.

46. A system for converting chemical energy stored in hydrogen into mechanical energy comprising:
a hydrogen storage container containing at least an hydrogen storage composition and hydrogen, the hydrogen including solid state hydrogen and gaseous hydrogen, the hydrogen storage composition including at least a portion of the solid state hydrogen and having an equilibrium desorption plateau pressure at 20° C. of greater than 40 bars, wherein the gaseous hydrogen has a pressure greater than the equilibrium desorption plateau pressure of the hydrogen storage composition; and
a vehicular engine fluidly coupled to the container for receiving the gaseous hydrogen.

47. The system as claimed in claim 46, wherein the hydrogen storage composition has an equilibrium desorption plateau pressure at 20° C. of greater than 80 bars

48. The hydrogen storage container as claimed in claim 47, wherein the hydrogen storage composition has an equilibrium desorption plateau pressure at 20° C. of less than 120 bars.

49. The system as claimed in any of claims 46 to 48 claim 46, wherein the hydrogen storage composition is a metalliferous material.

50. The system as claimed in claim 49, wherein the hydrogen storage composition is a metal hydride.

51. The system as claimed in claim 50, wherein the solid state hydrogen defines at least 5% by weight of the total weight of the contained hydrogen and the gaseous hydrogen defines at least 5% by weight of the total weight of the contained hydrogen.

52. A method of effecting hydrogenation of a hydrogen storage composition disposed in a container space defined by a hydrogen storage container configured for containing at least hydrogen and the hydrogen storage composition, the hydrogen storage composition having an high equilibrium plateau pressure, comprising the step of:
flowing gaseous hydrogen into the container space so as to effect hydrogenation of the hydrogen storage composition at least until the hydrogen storage composition includes solid state hydrogen and the solid state hydrogen defines at least 5% by weight of the total weight of hydrogen disposed within the container space, and so as to effect filling of the container space with the gaseous hydrogen at least until the gaseous hydrogen disposed within the container space defines at least 5% by weight of the total weight of the hydrogen disposed within the container space.

53. The method as claimed in claim 52, wherein the hydrogen storage composition has an equilibrium desorption plateau pressure at 20° C. of greater than 40 bars, and the filling of the container space with the gaseous hydrogen is effected until the gaseous hydrogen disposed in the container space has a pressure greater than the equilibrium desorption plateau pressure.

54. The method as claimed in claim 53, wherein the hydrogen storage material is a metalliferous material.

55. The method as claimed in claim 54, wherein the metalliferous material is a metal hydride.

56. The method as claimed in claim 55, wherein the metal hydride is in particulate form.

57. The method as claimed in claim 52, wherein the hydrogen storage composition has an equilibrium desorption plateau pressure at 20° C. of greater than 80 bars, and the filling of the container space with the gaseous hydrogen is effected until the gaseous hydrogen disposed in the container space has a pressure greater than the equilibrium desorption plateau pressure.

58. The hydrogen storage container as claimed in claim 57, wherein the hydrogen storage composition has an equilibrium desorption plateau pressure at 20° C. of less than 120 bars.

59. The method as claimed in claim 58, wherein the hydrogen storage material is a metalliferous material.

60. The hydrogen storage container as claimed in claim 59, wherein the metalliferous material is a metal hydride.

61. The hydrogen storage container as claimed in claim 60, wherein the metal hydride is in particulate form.
